(19) United States
(12) Patent Application Publication
(10) Pub. No.: US 2012/0073158 A1
(43) Pub. Date: Mar. 29, 2012

(54) Slim vent-expandable dryer exhaust vent system

(76) Inventors: Joseph Sciallo, Boca Raton, FL (US); Barry Krohn, Boca Raton, FL (US)

(21) Appl. No.: 12/928,299

(22) Filed: Dec. 8, 2010

Related U.S. Application Data
(63) Continuation-in-part of application No. 12/924,513, filed on Sep. 29, 2010, now abandoned.

(51) Int. Cl. F26B 25/00

(52) U.S. Cl. 34/235

(57) ABSTRACT

System for installation of a complete, safe, compact, and efficient one piece dryer exhaust. Provides a removable end cap for access to internal areas of conduit for dryer lint build-up removal. This will allow the removal of built up lint which is a potential fire hazard, which current available products lack. Has a recessed collar/sleeve connector to the outside wall port. Allows dryer placement in tight confines: laundry closets, pantry areas, first floor apartments, anyplace where space for a dryer vent is limited. System may be used to route dryer exhaust conduit inside of dwelling walls.

This is a continuation in part of application Ser. No. 12/924,513 filed Sep. 29, 2010.

### FIELD OF INVENTION

The present invention relates to a one piece exhaust vent system. More specifically, to a low profile one piece exhaust venting system, with removable end cap for cleaning interior of exhaust venting system for clothes dryers, recessed collar/sleeve connector for outside exhaust, integrated locking system and one piece construction.

### BACKGROUND OF THE INVENTION

By their design function, dryer exhaust conduits conduct substantial quantities of heated exhaust air from the dryer to an outside vent. The heated air contains significant amounts of water vapor and lint. In the case of natural gas fired dryers, carbon monoxide and other harmful combustion gases are routed out through the vent system as well.

The nature of the exhaust air in conjunction with the typical dryer vent installation can cause problems. Manufactures generally recommend that dryer installations be completed with metal or other rigid or articulated semi rigid fixed conduit. This is an attempt to steer consumers away from the use of ribbed, flexible vinyl or foil tubing. While the familiar ribbed vinyl or foil tubing serves the intended purpose and has become the mainstay installation of “do-it-yourselfers” and discount appliance or other low cost appliance providers, it has drawbacks and dangers. These drawbacks fall into the areas of safety and efficiency.

Dryer exhaust vent installations constructed of vinyl or other soft tubing are inherently unsafe and inefficient because the flexible tubing lacks the intrinsic physical support of a rigid or semi rigid metal system and is a poor conductor of the heated, moisture and lint laden, dryer exhaust. The intrinsic flexibility of the soft tubing types allow for excessive bending and kinking that can cause significant airflow restrictions or blockages. This, is turn, allows for the unsafe build-up of lint, exhaust heat, and toxic fumes. At minimum, this condition lowers the efficiency of the dryer over time. At worst, it precipitates the numerous fires (between 11,000 to 14,000 by consumer protection group estimates) started by improper venting of home dryers each year. Even if the flexible tubing is routed with the proper consideration to avoid kinking or blockages, the tubing itself collects significant amounts of lint on its internal surface when combined with the water vapor content of the dryer exhaust air.

An additional safety concern is the materials used in these flexible tubing products. The vinyl tubing, by its nature, is combustible and the foil tubing is an inadequate construction of a thin, lightweight aluminum covering over a spring wound with heavy paper. Thereby, not only would either type of soft tubing fail to contain a conduit fire should one start both types would offer an additional combustion source if the overheated lint buildup should ignite.

As mentioned above, efficiency of the dryer's venting system coincides with its safety considerations. The use of flexible tubing as well as the typical industry standard round pipe can limit the dryer's efficiency. The limitations fall generally in the area of the physical installation. Both the flexible tubing and the standard round pipe have space and placement considerations for the installer. The tubing and round pipe both have to be routed to accommodate their diameter and the radius turns necessary to complete the installation. This translates into the inability to place the dryer in close proximately to the wall. There must be a standoff area allowed for the tubing or pipe to the turned out away from the back of the dryer and a corresponding space accommodation where the vent turns into the wall. Certain installations are non-critical in this respect, locating a dryer in a wide open, basement of a single family home, for example. However, quite often space is at a premium for the installation of today's modern appliances. Dryers are often paired with washers in cramped first floor apartment closets or shoehorned into small pantry spaces. Even the wide open basements of a single family homes can no longer afford to waste space by placing a dryer well away from a back or side wall. Efficiency also is lost in the luxury of a dryer vent installation that uses great amounts of free space. The dryer should have the shortest, most direct route to the outside wall vent. This minimizes airflow losses to lint buildup and reduces the chance of occurrence of vent blockages. Since the long term build up of lint particulate is of critical concern, it should also be noted that the typically flexible tubing installation is in one long singular piece that does not generally facilitate or encourage regular disassembly and cleaning by the consumer. This again causes concern as a fire hazard. This non-accessible, permanent type of installation also plagues the other typical rigid type of dryer vent conduits available today. The consumer is not predisposed to effect cleaning of the dryer vent after it is installed and enclosed.

Therefore, it is the design intention of the present invention to overcoming these shortcomings. The low profile dryer vent exhaust system provides a compact and efficient short route to the outside vent by utilizing a one piece rectangular or oval profile for its exhaust conduit; said conduit may be situated either on the interior or exterior of the interior wall where the outside exhaust vent 280 is located. This allows for a rigid/semi rigid, substantial ductwork system that turns tight and has minimal radii. A unique feature of the system provides the homeowner with an access port for periodic cleaning, inspection, and removal of lint buildup which can be a major source of fire. The rigid/semi rigid metal construction eliminates the problems with conduit combustibility and significantly lowers the rate of lint build up.

### SUMMARY OF THE INVENTION

It is a first object of the present invention to provide a unique feature to a dryer exhaust system that allows the homeowner access to the internal areas of the exhaust conduit for the periodic removal of built up dryer lint for safety in fire prevention and for energy savings in maintaining peak dryer efficiency.

It is a second object of the present invention to provide a low profile rigid/articulated semi rigid dryer vent exhaust system that allows for a close fit placement of a clothes dryer to a wall.

It is a third object of the present invention to provide a semi rigid articulated section for the vent exhaust system that allows the vent to shaped by means of its articulated section, so that it may be formed to go around any obstacle that may obstruct its path to the exhaust vent.

It is a fourth object of the present invention to provide easy access to the dryer exhaust system by placing a removable end cap on the dryer exhaust for quick access for the removal of built up dryer lint.

According to a first aspect of the present invention a low profile exhaust vent system is provided. The system is rigid/articulated semi rigidly connected in a generally permanent configuration providing strength and security for the dryer vent system to safely pass large quantities of hot damp exhaust air to an outside vent outlet. Typical dryer vent installations are prone to the build up of, and ultimate blockage by, the large quantities of lint ambient in the exhaust air. At minimum, there is a gradual but substantial reduction in the drying efficiency of the appliance. More importantly however, there is a serious risk of fire when the lint builds to the point of blockage. These blockages may occur simply on their own or be additionally precipitated by a poor vent installation through the use of flexible tubing. When the exhaust vent becomes blocked the combustible nature of the lint creates a fire hazard.

The present invention is designed to overcome the typical fire danger caused by lint buildup and vent blockage inherent to all dryer exhaust vent conduit systems. This dryer exhaust vent system is constructed of rigid/semi rigid metal conduit. The rigid/semi rigid construction prevents the creation of tight bend kinking or conduit crushing inherent with common flexible systems. A certain section of the present invention contain a removable end cap to allow the homeowner access to the inside of the conduit. This removable end cap opening allows the insertion of a vacuum source to remove the lint buildup. A typical home vacuum with an extension hose and a crevice tool will provide the homeowner with the ability to perform periodic lint cleanings of the dryer exhaust vent system thereby ensuring continued safe and efficient operation of the dryer.

According to a second aspect of the present invention a low profile exhaust vent system is provided. The system mechanically connects a typical, commercially available clothes dryer to an outside vent located in the wall structure of the home. The dryer vent system utilizes a oval, or rectangle shaped rigid/articulated semi rigid metal conduit with a generally rectangular cross-sectional area. This vent system with its “flattened” cross-sectional area allows the dryer a much closer physical placement to the wall behind the dryer. The vent connection is more compact and efficient. This is especially ideal in close quarter situations as in apartment installations where the dryer may be located in a small closet or alcove.

The present invention also embodies a low profile one piece connection fitting for locating a dryer close to a back wall when the outside wall vent connector is within very close proximity to the dryer outlet connector. In typical installations this situation causes the dryer to be placed out away from the wall. This is because the radius of the dryer outlet connection and the radius of the wall vent connection, as well as the diameter of the round pipe connector must be all accounted for in the vent pipe connection. The present invention embodiment is low profile, flexible and adjustable and can provide a very close dryer placement to the wall in a quick, easy, and safe one-piece installation. The present invention also has an embodiment for applications in new construction and major remodeling. Standard width dwelling walls are generally constructed around the industry standard 2″ inch×4″ inch piece of construction lumber. The standard 2″ inch×4″ lumber measures in practical terms much closer to 3 and ½ inches in width and 1 and ½ inch thick. This measurement forms the width of the open space within the constructed walls. In many of the various close fit washer/dryer installation situations described above, the building contractor is forced to route the dryer exhaust conduit vertically, in elevation, inside a standard width wall to another elevation. Beyond the present invention there exists no currently available method to cleanly route the dryer exhaust system vertically inside the narrow wall space to mate with an outside vent outlet placed at a different elevation. This means that often dryers are vented into open crawl spaces, or wall spaces, or that standard round conduit is employed and crushed to fit. Venting to an open space within, or under, or above the living space or the use of crushed, mangled vent pipe in the wall causes the undesirable and unsafe conditions of high concentrations of water vapor, lint and possibly toxic fumes or mold within the home. If dryer placement within the dwelling is such that vent conduit routing must run vertically, in elevation, inside a standard wall, the low profile dryer exhaust system fits cleanly and easily into a standard width wall. An adapter is one of the preferred embodiments that allow this system to be routed through interior walls.

These and other objects, aspects, and advantages of the present invention will become apparent upon reading the following detailed description in combination with the accompanying drawings.

### BRIEF DESCRIPTION OF THE DRAWINGS

FIG. 1 is a perspective view of the one piece low profile exhaust vent in a 90 degree articulated position 46 that is made in accordance with the teachings of the preferred embodiment of the invention, to attach the dryer's exhaust outlet 156 and to a outside outlet vent 108 in the wall;

FIG. 1-A where 136 is the wired spring assembly.

FIG. 1-A is attached across the length of FIG. 2-A 94, and the ends of 136, looped end 152 and hooked end 96 are inserted through 82, 84 and through FIG. 5-A 32 and 98. simultaneously allowing FIG. 2-A to be locked securely to the top section of FIG. 5-A 218 in the closed position.

FIG. 2 is a perspective view of the one piece low profile exhaust vent 150 and clothes dryer 90 in a vertical position that is made in accordance with the teachings of the preferred embodiment of the invention, to attach the dryer's exhaust outlet 156 in FIG. 1. and to a outside outlet vent 108 in the wall.

FIG. 2-A A new embodiment for the upper portion of invention with removable end cap. Where 94 is the removable end cap that can be shaped in an oval, rectangle or circular configuration. The one piece construction is a stamped piece of metal that has a flat top 92, and running the circumference of 94 bent 90 degrees relative to the sides of 94, traversing the circumference of 94. Hole location FIG. 1-A 136, are located at 82, 84 and FIG. 5-A 32. 98.

FIG. 2-A is than placed on top of FIG. 6-A whereby the lid of FIG. 2-A 94, fits on top the upper rim formed by 222 in FIG. 5-A and FIG. 3-A. and is none crimped for easy removal.

FIG. 2-B A new embodiment for the upper portion of invention with removable end cap. Where 94 is the removable end cap that can be shaped in an oval, rectangle or circular configuration. The one piece construction is a stamped piece of metal that has a flat top 92, except that 234 is added to the front edge of 94, which shows 234 bent 180 degrees relative to cover 222 when assembled. Hole location FIG. 2-B 94, are located at 82, 84 and FIG. 5-B 32, 98.

FIG. 3 is a full view of the dryer exhaust vent 150 in a 90 degree articulated bend. The one piece low profile dryer vent exhaust system used by itself to connect a typical clothes dryer to the outside wall outlet collar/sleeve connector 100, and dryer exhaust collar connector 60.

FIG. 3-A is a frontal perspective of the front metal face plate 212, a notched 132 venting single walled collar/sleeve 120, with a tightening locking/securing device 160,170.

FIG. 3-B is a frontal perspective of the front metal face plate 212, venting single walled collar/sleeve 120.

FIG. 4-A Side perspective of FIG. 3-A with collar/sleeve 120 on the interior of FIG. 5-A when assembled to form 6-A 220.

FIG. 4-B side view of FIG. 3-B.

FIG. 4 is the top view of an additional embodiment of the rectangular one piece dryer exhaust vent 30. Shown in the closed position is the removable end cap 94, and the supporting spring mechanism 136. The outside collar/sleeve exhaust vent connector 100 and the clothes dryer exhaust collar/sleeve connector 60.

FIG. 5-A rear and side embodiments of FIG. 6-A. It is a stamped piece of metal 218 bent into shape to form 210, that has a flat, oval, or rounded shape 218, with channels 216, running vertically to 218. Holes 98, 32 are placed near the top to receive FIG. 1-A. 152 and 96.

FIG. 5-B A rear and side embodiments of FIG. 6-A. It is a stamped piece of metal 218 bent into shape to form 210, that has a flat, oval, or rounded shape 218, with channels 216 running vertically to 218. Holes 98, 32 are placed near the top to receive FIG. 1-A. 152 and 96. With the addition of tabs 224, and holes 226.

FIG. 5 is the top and frontal view of an additional embodiment of the rectangular dryer exhaust vent 130. Shown in the opened position is the removable end cap 94, and the supporting spring mechanism 136. The outside exhaust vent collar/sleeve connector 100.

FIG. 6-A Assembled embodiment of FIG. 1-A, FIG. 2-A, FIG. 3-A and FIG. 5-A. Assembly is by sliding FIG. 3-A, 212 into the channels of FIG. 5-A 216, and crimp 216 to secure FIG. 5-A 210 with FIG. 3-A 212.

FIG. 6-B is the complete assembly 220, of FIG. 1-A, FIG. 2-B, FIG. 3-B, FIG. 5-B.

FIG. 6 is the top view of an additional embodiment of the oval dryer exhaust vent 30. Shown in the closed position is the removable end cap 94, and the supporting spring mechanism 136. The outside exhaust vent collar/sleeve connector 100 and the clothes dryer exhaust collar/sleeve connector 60.

FIG. 6-B is the complete assembly 220, of FIG. 1-A, FIG. 2-B, FIG. 3-B FIG. 5-B.

FIG. 7 is the top frontal view of an additional embodiment of the oval dryer exhaust vent 130. Shown in the opened position is the removable end cap 94, and the supporting spring mechanism 136. The outside exhaust vent collar/sleeve connector 100.

FIG. 8 is a full frontal view showing the entire perspective of the one piece low profile dryer exhaust vent system.

FIG. 9 is a full side perspective view of the one piece low profile dryer exhaust vent system.

FIG. 10. is a perspective view of the side elevation of FIG. 3

FIG. 11 is a perspective view of the frontal elevation of FIG. 10

FIG. 12 is a perspective top view of FIG. 10 and FIG. 11

FIG. 13 is a partial perspective view of FIG. 10 with a new embodiment of the dryer exhaust vent collar/sleeve 112 of FIG. 13, where said collar is made of two separate rings 120 and 122 that are connected by the lower edge 124 forming the base of 120 and 122.

FIG. 14 is a perspective top view of FIG. 13

FIG. 15 is a perspective view of the full embodiment view of FIG. 13 and FIG. 14.

FIG. 16 is a perspective top view of FIG. 13 with closed lid 94.

FIG. 17 is a perspective view of a cut away section of collar/sleeve 120, 122, 115, 116, 118 and 124.

FIG. 18 is a frontal view of FIG. 16 with recessed collar side 112.

FIG. 19 is a perspective view from the top to bottom of FIG. 15 with opened lid 94.

FIG. 20 is the top view of an additional embodiment of the rectangle one piece low profile dryer exhaust vent 30. Shown in the closed position is the removable end cap 94,

The perspective is from the top exhaust vent and recessed collar/sleeve 120 with notched spaces 132, to the bottom of the exhaust vent collar 60.

FIG. 21 is the top view of an additional embodiment of the rectangle one piece low profile dryer exhaust vent 30. Shown in the closed position is the removable end cap 94, The perspective is from the top exhaust vent and recessed collar/sleeve 120 with notched spaces 144, to the bottom of the exhaust vent collar/sleeve 60. A new embodiment of FIG. 21 is that recessed collar/sleeve is shaped by rectangle cutouts 144 as rectangle spaces. FIG. 22 is the top frontal view of an additional embodiment of the rectangle one piece low profile dryer exhaust vent 30. Shown in the opened position is the removable end cap 94, The perspective is from cut away section of the top exhaust vent and recessed collar/sleeve 120 with notched spaces 132.

FIG. 23 is a partial longitudinal view of a new embodiment of the dryer one piece exhaust dryer vent in that it is circular in design 42.

FIG. 24 is a top to bottom perspective view 30 of FIG. 25. The perspective is from the top one piece dryer exhaust vent and recessed collar/sleeve 112 with notched spaces 132, to the bottom of the exhaust vent 60.

FIG. 25 is a sectional longitudinal view of the entire one piece dryer exhaust vent 80, 136, 94, 64, 112, 40, 50,30.

FIG. 26 is a top perspective of the one piece low profile dryer exhaust vent showing a single recessed collar/sleeve embodiment 120 with angle brackets 160 and screw and nut attachment 170.

FIG. 27 an embodiment of a securing method for the recessed collar/sleeve 120 for the one piece dryer exhaust vent to the outside. The recessed collar/sleeve 120 is solid with a notch 132 cut into the solid collar/sleeve 120 used in conjunction with attached with two metal shaped wires 164.

FIG. 28 an embodiment of a securing method for the recessed collar/sleeve 120 for the dryer exhaust vent to the outside 112. The outer ring of the recessed collar/sleeve 120 is solid with a notch 132 cut into the solid recessed collar/sleeve 120 used in conjunction with attached with two metal shaped wires 168.

FIG. 29 an embodiment of a securing method for the recessed collar/sleeve 120 for the dryer exhaust vent to the outside 112. The outer ring of the recessed collar/sleeve 120 is solid with a notch 132 cut into the solid recessed collar/sleeve 120 used in conjunction with the attached recessed collar/sleeve 120 with two “L” brackets 160 that have holes 198 in each shaped bracket, one placed on either side of the notch 132. A screw 170 pass through the holes 198.

FIG. 31 a stand alone drawing of the securing device of 164 FIG. 27/164. is made of rounded metal shaped wire 164. The securing device is shaped as the rounded end 172, lower section 174, middle section 176, upper inner section 178, upper rounded end section 180, upper outer section 182.

FIG. 33 a stand alone drawing of the securing device of 168 FIG. 28/168. The is made of rounded metal shaped wire 184. The securing device is shaped as the rounded end 184, lower section 186, middle section 188, upper inner section 190, upper rounded end section 194, upper outer section 192

FIG. 35 a stand alone drawing of the securing device of FIG. 29/160 and 170. This is made of a flat metal shaped into an “L” bracket 160. The securing bracket is shaped as the end of the portion concave shape 196, bottom section has a concave form 208, side edge 206 of 160, upper section of 160/204, side edge 202 of 160, hole 198 of 160, top edge 200 of 160.

FIG. 37 is a top frontal perspective of the low profile exhaust vent showing the recessed collar/sleeve 120 with securing device 168.

FIG. 39 is a partial longitudinal side view of the exhaust vent showing recessed collar/sleeve 120 with securing device 160, 170.

FIG. 41 is the top view of the exhaust vent showing recessed collar/sleeve 120 with securing device 160, 170.

FIG. 43 is a perspective side view of the frontal longitudinal elevation of the exhaust vent showing the recessed collar/sleeve 120 and securing device 160,170.

FIG. 45 is the top view of the exhaust vent showing recessed collar/sleeve 120 with securing device 164.

FIG. 47 is a frontal view of FIG. 39 with recessed collar/sleeve side 112.

FIG. 49 is a top perspective of FIG. 45 with lid in an open position of the low profile exhaust vent showing the recessed collar/sleeve 120 with securing device 160,170.

FIG. 51 is a flat rectangular metal lid 228. Attached to the upper portion of the flat rectangular surface is placed an “L” shaped metal handle 230.

FIG. 51-A front view of the metal face plate 212, an additional embodiment 232, in that the top horizontal plane is bent into a 90 degree angle to the rear of 212, to receive FIG. 51/228.

FIG. 51-B A rear and side embodiments of FIG. 6-A. It is a stamped piece of metal 218 bent into shape to form 210, that has a flat, oval, or rounded shape 218, with channels 216 running vertically to 218. Holes 98, 32 are placed near the top to receive FIG. 1-A. 152 and 96. With the addition of tabs 224, and holes 226. The top horizontal plane of 218 has the rear edge 232, and one side edge 232, each being bent to a 90 degree angle, towards the interior of 218.

FIG. 51-C side view of FIG. 51-B.

FIG. 51-D the new embodiment is the slide in and out lid 228, as in the complete assembly 220, of FIG. 51, FIG. 51-A, FIG. 51-B.

FIG. 51-E is side view of FIG. 51-D.

FIG. 53 is the sliding ring for the new embodiment of the invention that is adaptable fully into the wall between wall studs. A circular ring 266 made of metal has attached to opposite sides of metal tabs 262 and 264, and has holes set in 262 and 264 at 268. This unit attaches to 234 of FIG. 55.

FIG. 59 is the ridged/semi-ridged exhaust vent 240. The upper ridged section 234 is shaped with reducing ridges to be inserted through 270 and fitted into the solid metal exhaust venting pipe of FIG. 61/280. Section 46 is the semi-ridged expandable portion of the exhaust vent 240. Section 48 is the solid section of exhaust vent 240, with a vertical section 60 extending out to form the inlet section of exhaust vent from the outlet section of the clothes dryer. Section 61 is the closed end of the embodiment 240.

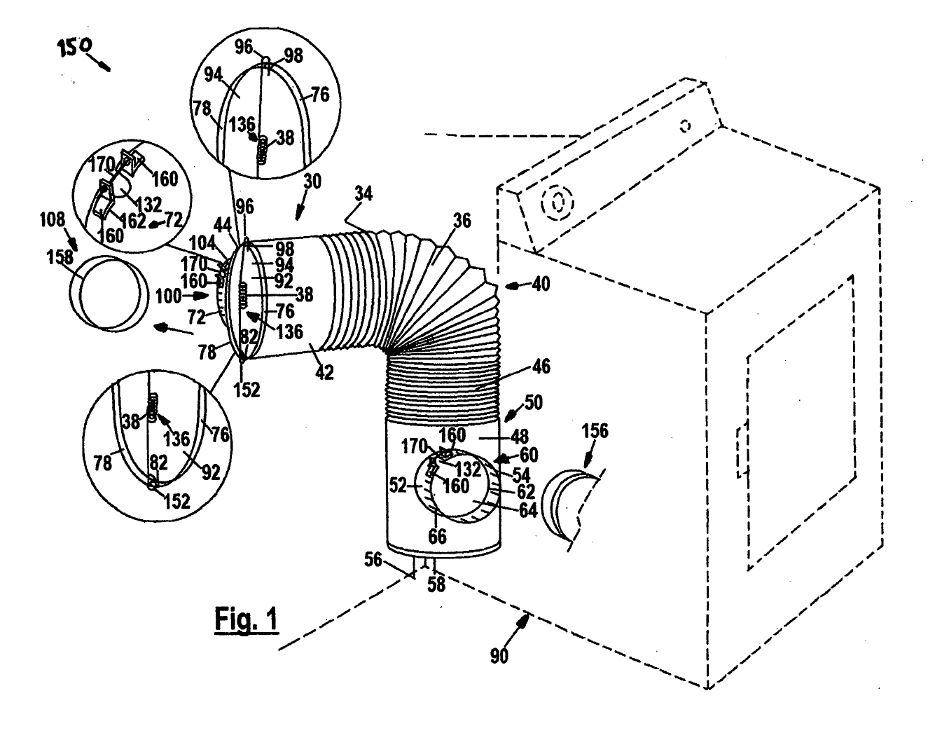

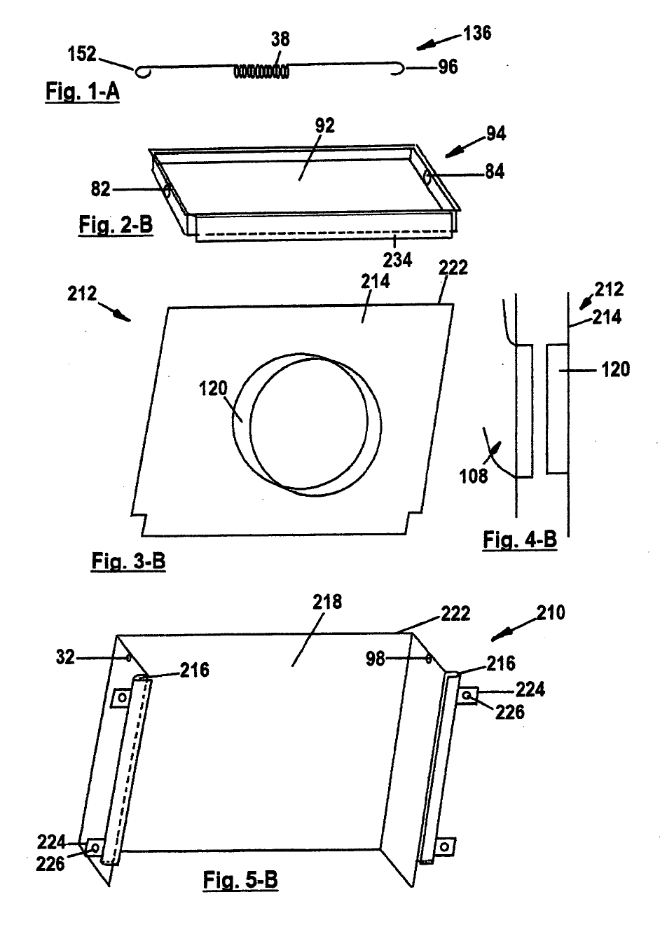

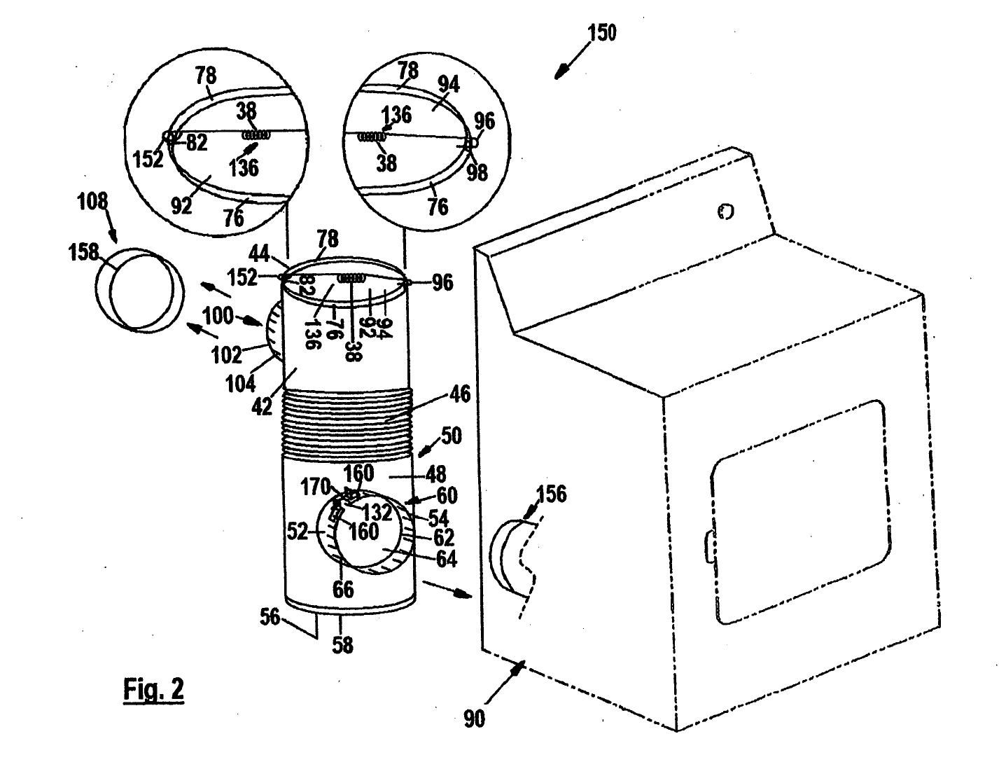

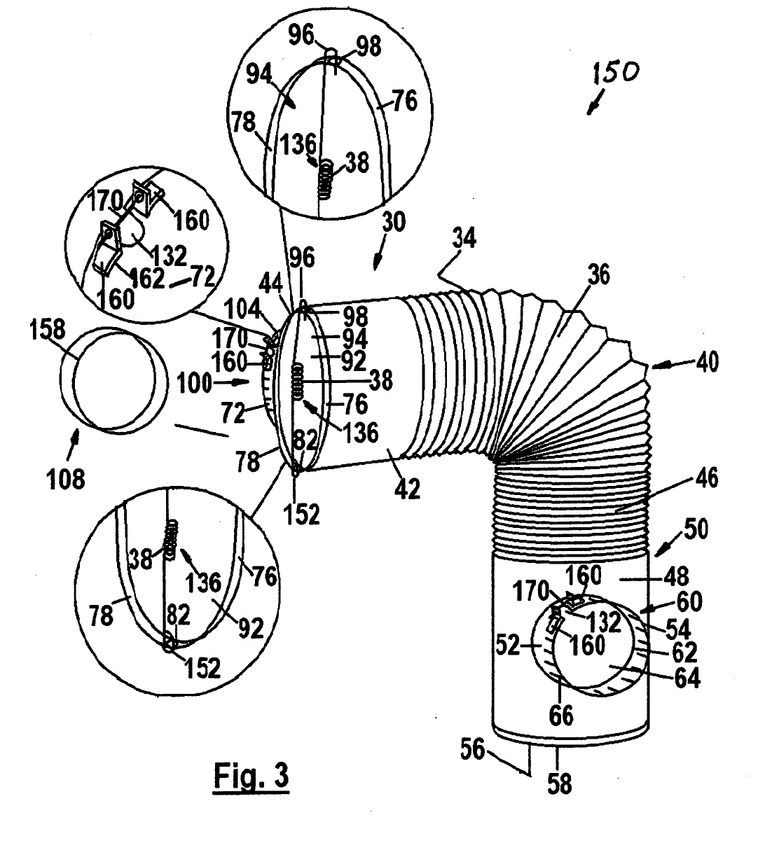

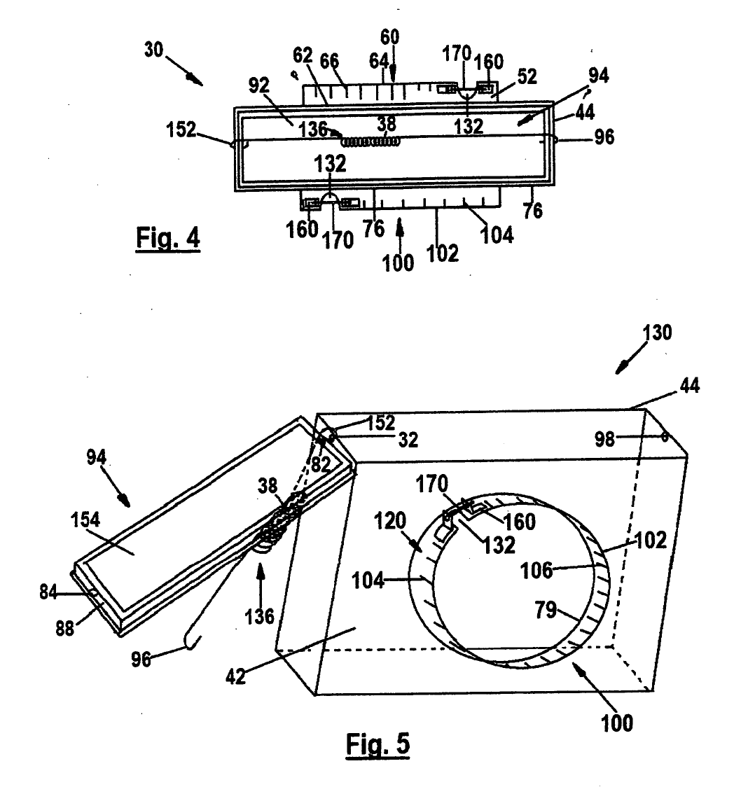

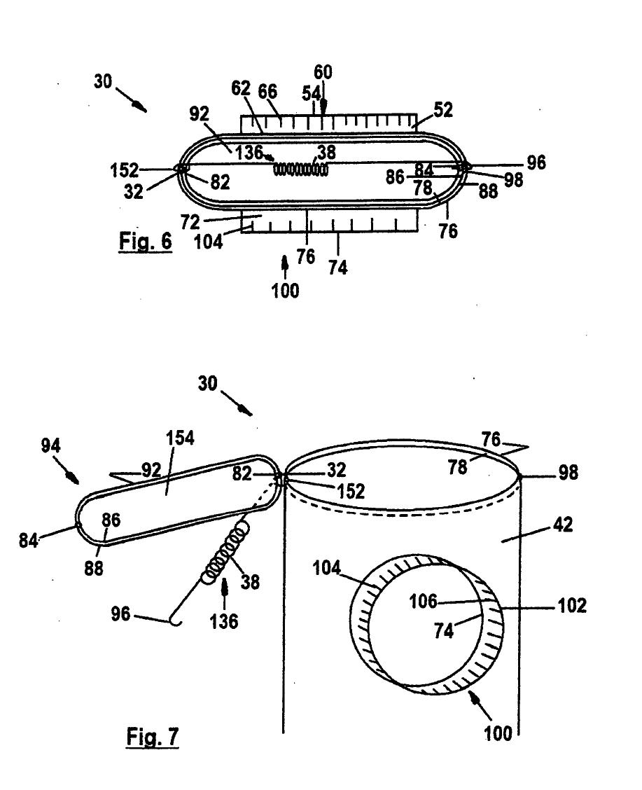

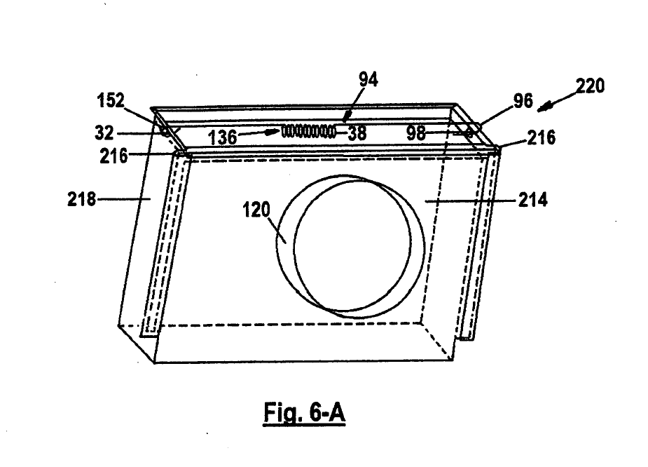

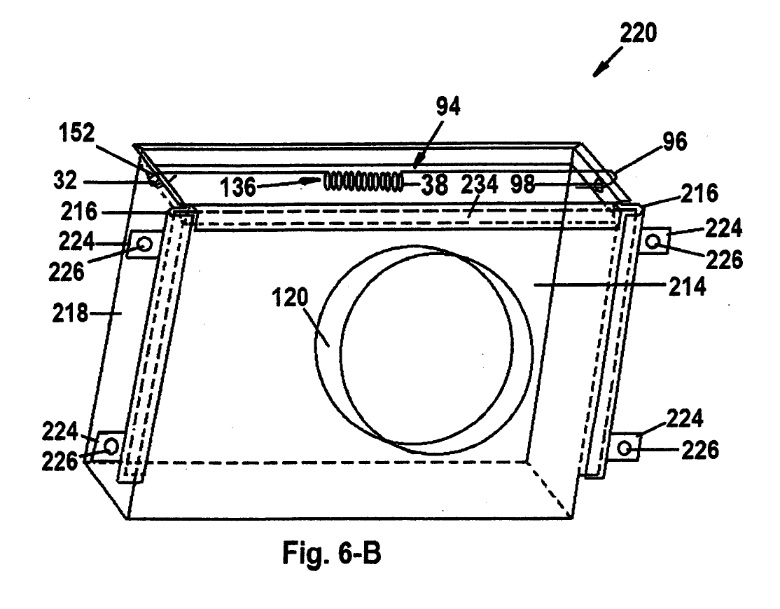

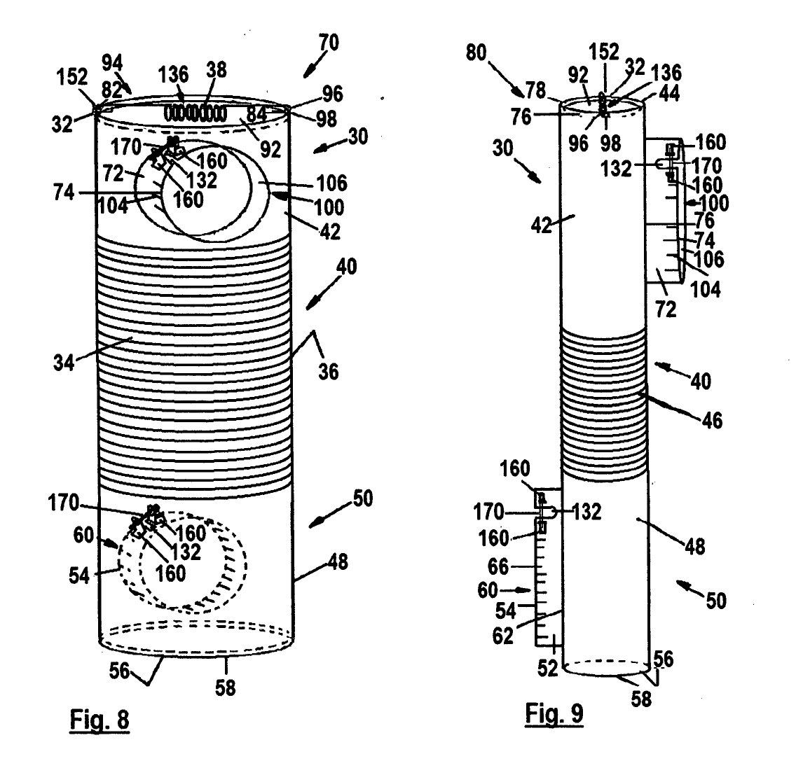

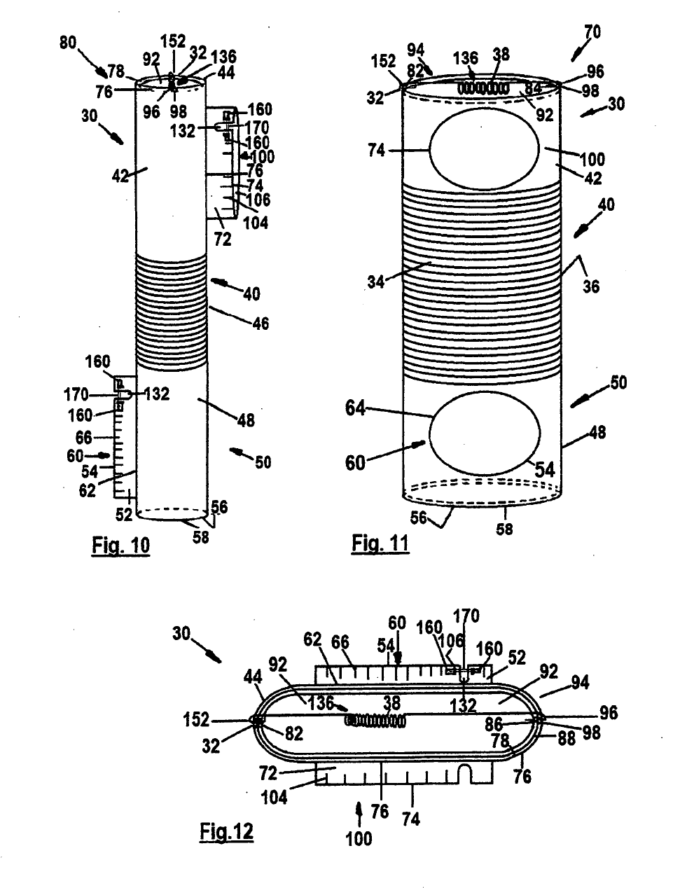

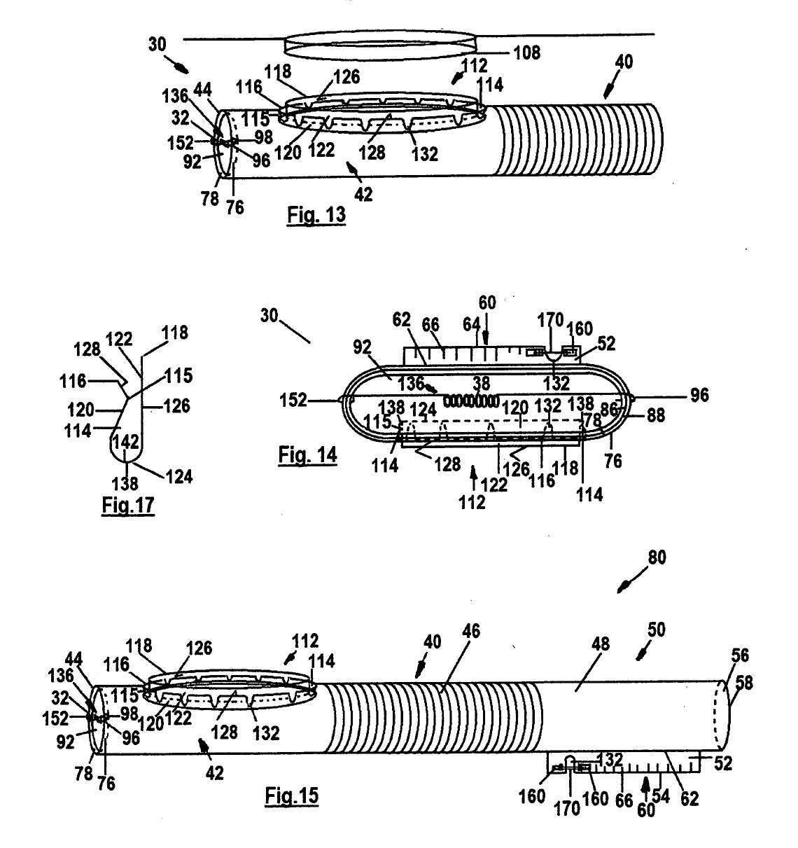

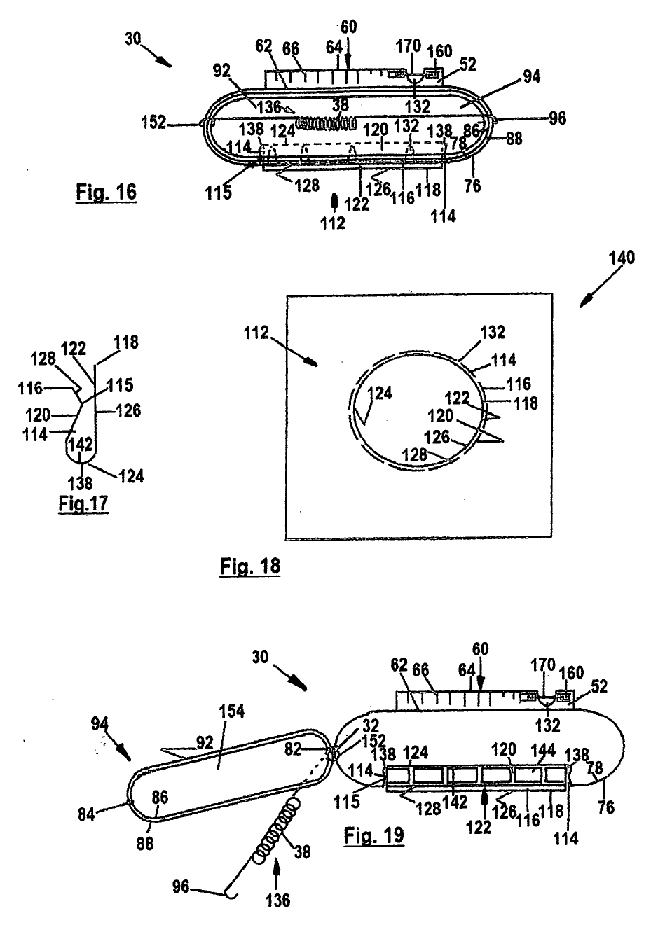

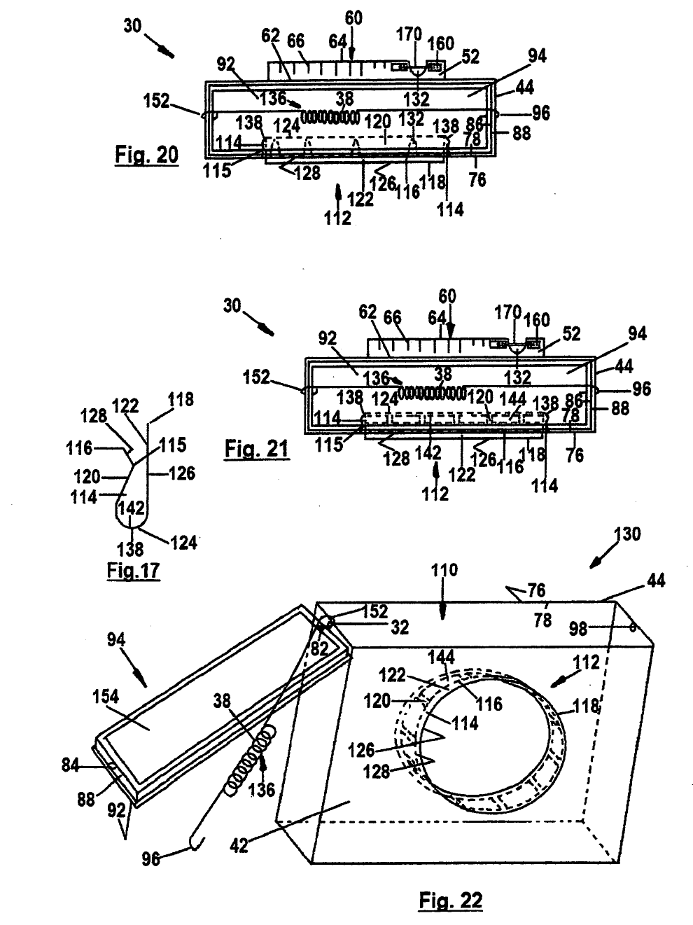

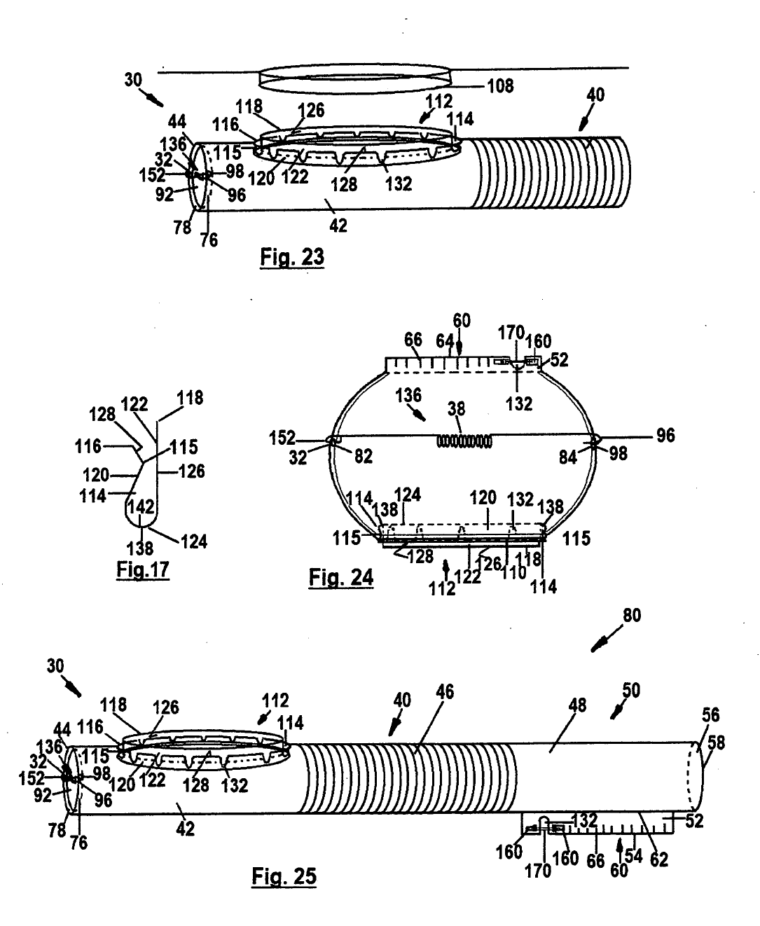

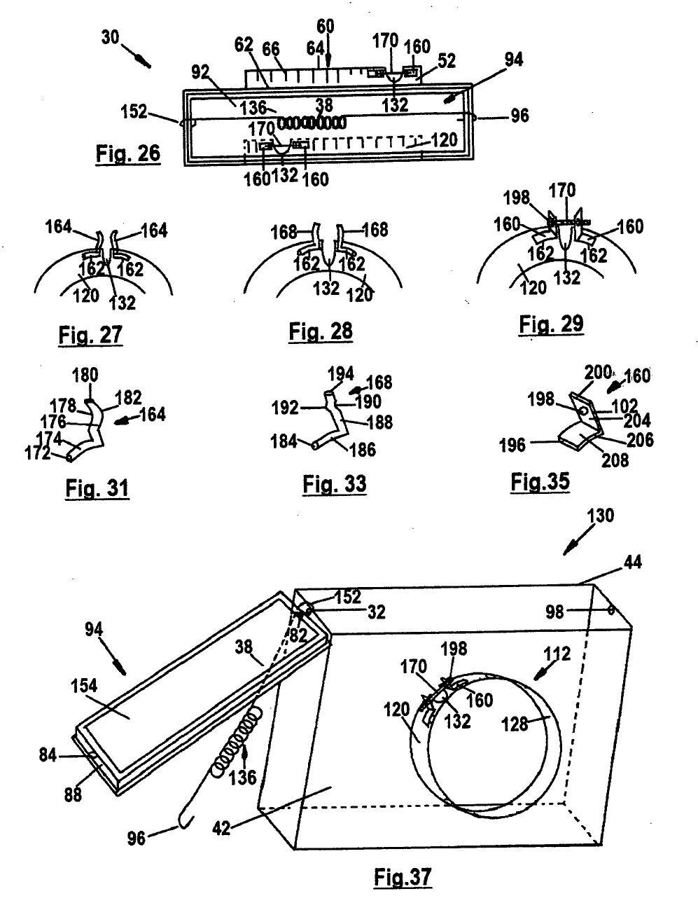

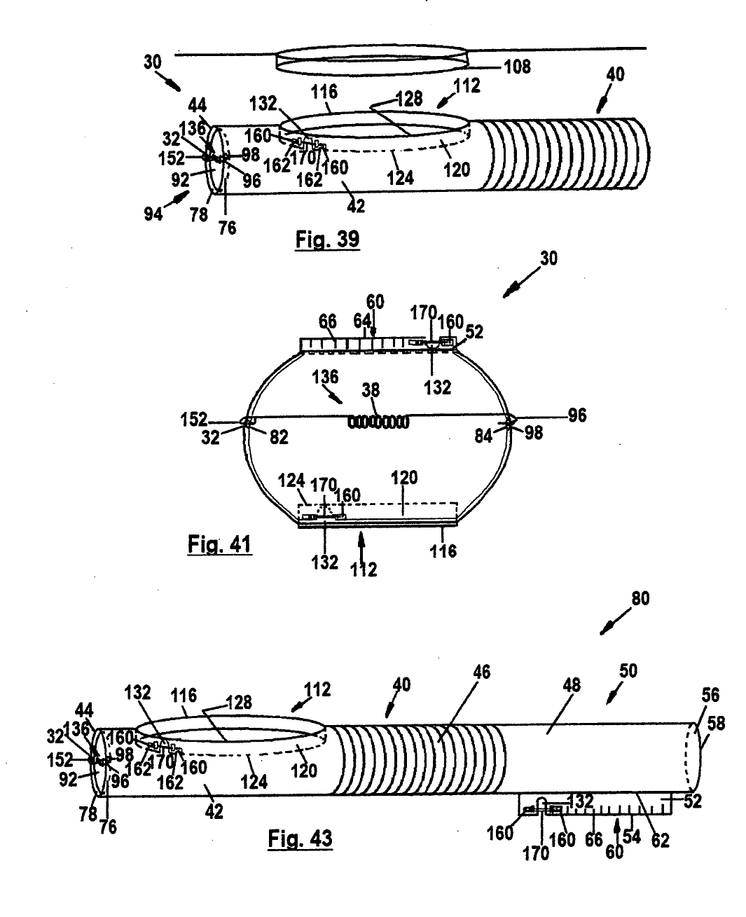

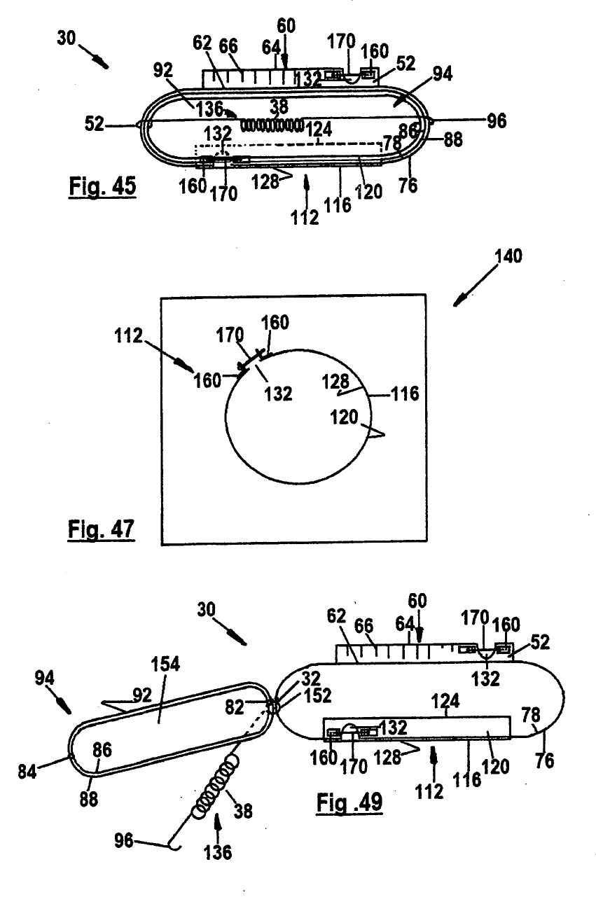

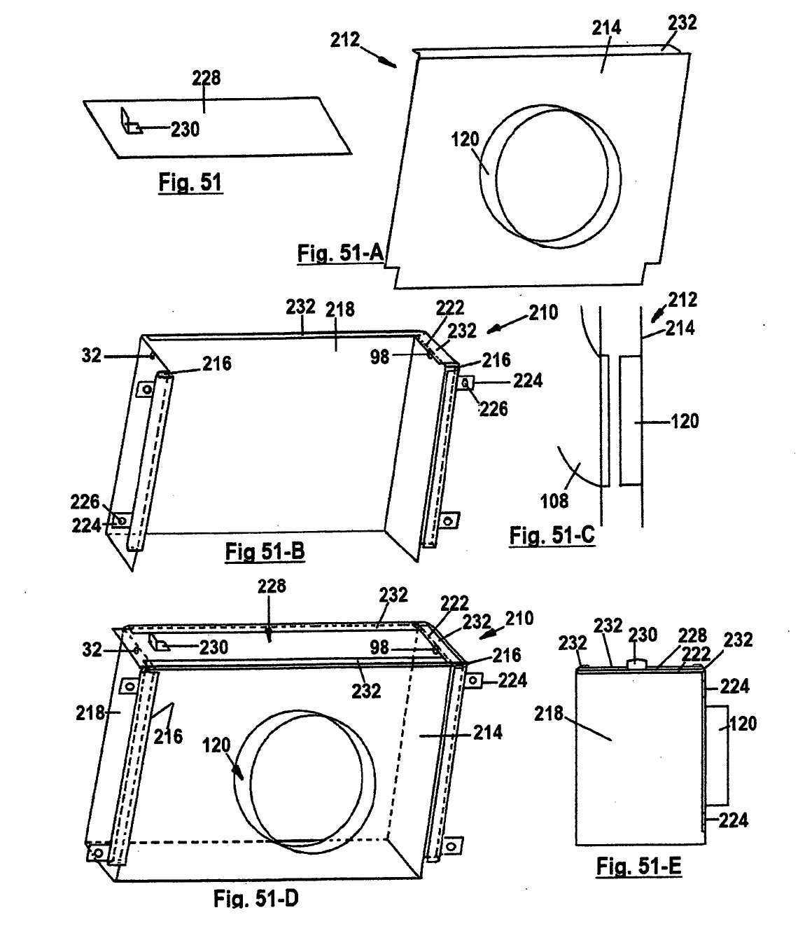

FIG. 57 is the upper embodiment of FIG. 61 made of sheet metal in the form of an open box like form 250 and 260, where the back 242 and 256 forms the rear of the embodiment, and where at right angle to 242 and 256 the sheet metal is formed 238, at the ends of 238 are bent outward at a 90 degree angle 244. the top of 250 between the upper ends of 238 and attached horizontally are flat metal rods 246. FIG. 53/262 and 264, 262 being the upper tabs and 264 being the lower tabs are situated so that the said metal rods 246 is situated between tabs 262 and 264.

Section 270 is able to traverse rods 246. FIG. 53/252 and 264 tabs have holes 268, through which a screw is placed so as to tighten 262 and 264 against 246 as a locking mechanism.

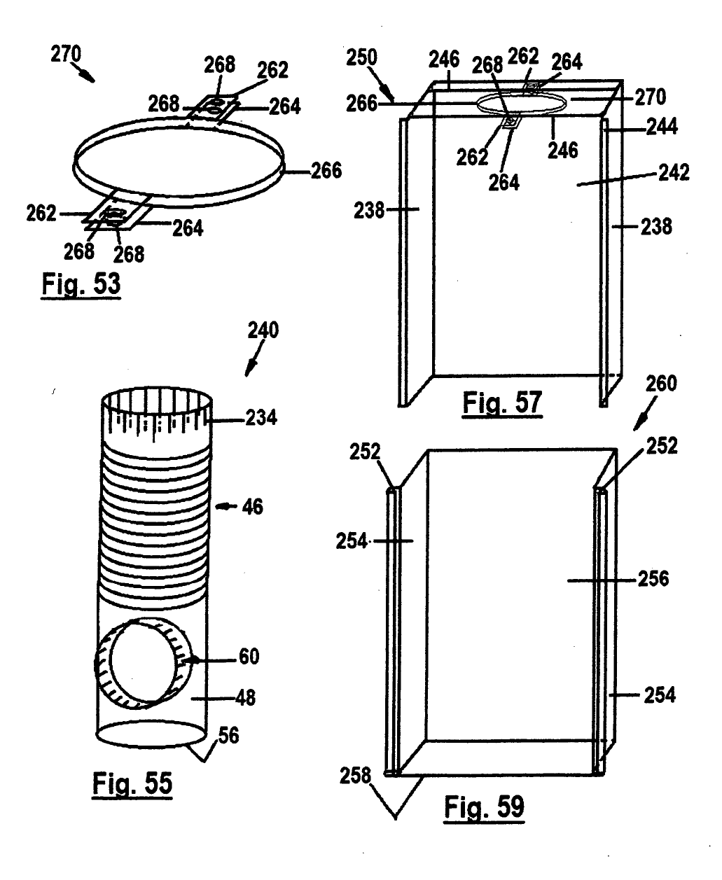

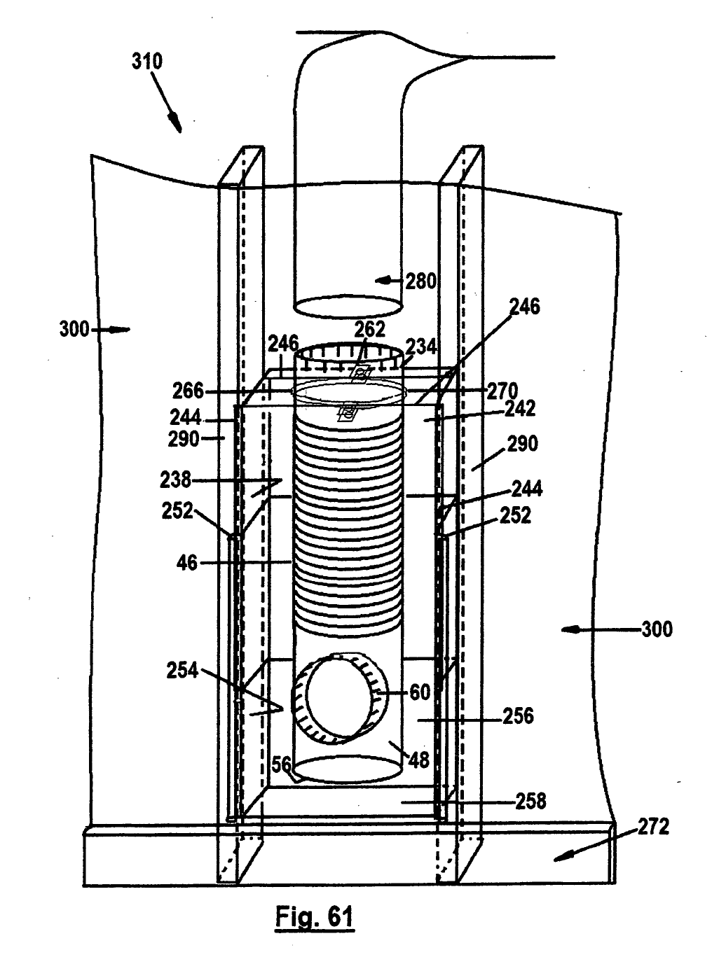

FIG. 59 is the lower portion of the embodiment of FIG. 61 and is made of flat sheet metal.

The three sided box like figure has a back 256, sides 254, bottom 258 and channels on either side of the open face 252 to receive metal edges of FIG. 57/244.

FIG. 61 is the entire embodiment of the dryer vent as shown in use. The dyer vent is placed inside a wall where the vent to the outside is located 280. The vent is located between standard 2″×4″ studs 290. The vent 240 is shown ready to be attached to outside vent 280.

What is claimed is:

1. A dryer exhaust vent connector comprising a member comprising of the lower closed section made of non-expandable shaped aluminum , an upper section made of non-expandable shaped aluminum, Between the lower section and the upper section is situated a shaped expandable section. The upper non-expandable section having a removable end cap, thereby allowing a one piece low profile exhaust vent to be selectively cleaned. Said member having a vent pipe connector that would have a recessed collar/sleeve connector whereby the one piece exhaust connector from the dryer and the wall outlet collar connector would fit inside said one piece low profile dryer vent and/or a crimped and reduction connector which cooperatively allow said member to operatively connect a clothes dryer to an outlet vent.

2. The one piece low profile vent of claim 1 wherein said member is either oval, rectangular, or circular.

3. A one piece low profile low profile dryer vent exhaust system which is adapted to attach an exhaust outlet of a dryer to an outlet vent, said exhaust system comprising:
a lower non expandable, generally either oval, circular or rectangle, metal element having a crimped vent pipe collar connector perpendicular to said member, with a built in locking or securing device on the collar/sleeve.
an upper non expandable element having a generally oval, circular or rectangular cross sectional area and having a vent pipe collar connector perpendicular to said element, with a built in locking or securing device on the collar/sleeve.
an upper non expandable member having a generally oval, rectangular or circular cross sectional area and having a removable end cap.
a spring loop and hook locking or securing device.
a middle element of expandable aluminum or any other expandable metal material connected to the top non expandable member, and said member connected to the lower non expandable member.

4. A dryer vent having a hollow member which has a generally oval, rectangular or circular cross sectional area and having a vent pipe collar connector having a recessed collar/sleeve member allowing the exhaust vent of the dryer and the outlet connectors to be inserted flush with said one piece low profile exhaust vent and/or a crimp and reduction area, said dryer connector. Further including upper and lower members which are attached to opposite sides of said hollow member and which cooperatively don't exceed the width of a 2″ inch by 4″ inch stud, when said exhaust vent is situated in the interior of said wall, allowing clothes dryer to be flush with the wall.

5. A one piece dryer exhaust vent that can have the upper outlet exhaust to the outside, and the lower outlet of the dryer can be on the same side of the embodied dryer exhaust vent.
A circular connecting opening for the exhaust from the dryer exhaust vent and the circular opening in the dryer vent outlet would be place so that each would be positioned on the same side of the dryer exhaust vent.
